(19) United States
(12) Patent Application Publication
(10) Pub. No.: US 2006/0209150 A1
(43) Pub. Date: Sep. 21, 2006

(54) Liquid ejection apparatus

(75) Inventor: Yuji Iwata, Suwa (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 11/384,942

(22) Filed: Mar. 17, 2006

(30) Foreign Application Priority Data
Mar. 18, 2005 (JP) 2005-079807

(51) Int. Cl. B41J 2/01

(52) U.S. Cl. 347/102; 427/511

(57) ABSTRACT

A liquid ejection head 30 is secured to a lower surface of a carriage 29. A nozzle plate 31, a drying laser radiation device 38, and a baking laser radiation device 39 are adjacently arranged at the lower surface of the liquid ejection head 30. A plurality of nozzles N are defined in the nozzle plate 31 and eject droplets Fb. The drying laser radiation device 38 includes a plurality of first semiconductor lasers Lb for drying the droplets Fb that have been received by a substrate 2. The baking laser radiation device 39 includes a plurality of second semiconductor lasers Lc for subjecting the dried droplets Fb to baking.

### CROSS-REFERENCE TO RELATED APPLICATIONS

This application is based upon and claims the benefit of priority from prior Japanese Patent Application No. 2005-079807, filed on Mar. 18, 2005, the entire contents of which are incorporated herein by reference.

### BACKGROUND OF THE INVENTION

The present invention relates to liquid ejection apparatuses.

Typically, electro-optic apparatuses such as liquid crystal displays and organic electroluminescence displays (organic EL displays) include transparent glass substrates (hereinafter, referred to as substrates) for displaying images. One such substrate includes an identification code (for example, a two-dimensional code) that indicates encoded information regarding the name of the manufacturer or the product number. The identification code is formed by structures (defined by colored thin films or recesses) that are provided in selected ones of a number of data cells in accordance with a predetermined pattern.

In order to form an identification code, for example, Japanese Laid-Open Patent Publication No. 11-77340 and Japanese Laid-Open Patent Publication No. 2003-127537 describe a laser sputtering method and a waterjet method, respectively. In the laser sputtering method, a code pattern is formed on a film through sputtering. In the waterjet method, the code pattern is formed in the substrate by ejecting water containing abrasive onto the substrate.

However, in the laser sputtering method, in order to form a mark in accordance with a desired size, the distance between a metal thin film and the substrate must be set to several to several tens of micrometers. Thus, the opposing surfaces of the metal thin film and the substrate must be precisely formed to be flat and spaced from each other by a distance adjusted accurately in the order of micrometers. As a result, the laser sputtering method is applicable only to limited types of substrates, or cannot be used widely for general substrates. Further, in the waterjet method, water, dust, or abrasive is splashed onto the substrate when forming the mark, leading to contamination of the substrate.

To solve these problems, an inkjet method has been focused on as an alternative method for forming the identification code. In the inkjet method, a liquid droplet containing functional material (metal particles) is ejected by a liquid ejection apparatus. The liquid droplet is then dried and thus a dot is formed. The inkjet method is thus applicable to a wider range of substrates. Further, the identification code is formed without contaminating the substrate.

However, the inkjet method involves a drying step and a baking step for baking the functional material of the droplet. In the drying step, the droplet is dried on the substrate and thus fixed. In the baking step, the functional material of the droplet is baked. That is, the drying step and the baking step are essential for obtaining a dot having an appropriate shape. It is thus necessary to improve efficiency for performing a drying procedure and a baking procedure when forming the identification code by the inkjet method.

### SUMMARY

Accordingly, it is an objective of the present invention to provide a liquid ejection apparatus that improves efficiency for performing drying and baking on a liquid droplet by accurately radiating a laser beam onto the liquid droplet ejected through an ejection port.

According to an aspect of the invention, a liquid ejection apparatus ejecting a liquid containing a functional material onto a substrate through an ejection port as a droplet is provided. The apparatus includes a first laser radiating portion that radiates a laser beam so as to dry the droplet that has been received by the substrate, and a second laser radiating portion that radiates a laser beam so as to bake the dried droplet.

According to another aspect of the invention, a liquid ejection apparatus ejecting a liquid containing a functional material onto a substrate through a plurality of ejection ports as droplets is provided. The apparatus includes a first laser radiating portion that radiates laser beams so as to dry the droplets that have been received by the substrate, and a second laser radiating portion that radiates laser beams so as to bake the dried droplets. The first laser radiating portion includes a plurality of first semiconductor lasers that are provided in correspondence with the ejection ports. The second laser radiating portion includes a plurality of second semiconductor lasers that are provided in correspondence with the ejection ports.

According to a further aspect of the invention, a method for forming a predetermined pattern on a substrate by ejecting a liquid containing a functional material on the substrate through an ejection port as droplets is provided. The method includes: drying the droplets that have been received by the substrate by radiating laser beams having a first wavelength; and baking the dried droplets by radiating laser beams having a second wavelength different from the first wavelength.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a front view showing a liquid crystal display module:

FIG. 2 is a front view showing an identification code;

FIG. 3 is a side view showing the identification code;

FIG. 4 is a plan view showing the cells and the dots defining the identification code;

FIG. 5 is a perspective view showing the liquid ejection apparatus;

FIG. 6 is a perspective view showing a liquid ejection head;

FIG. 7 is a side view schematically showing a liquid ejection head according to a first embodiment of the present invention;

FIG. 8 is a cross-sectional view showing a portion of the interior of the liquid ejection head;

FIG. 9 is a block diagram representing an electric circuit of the liquid ejection apparatus;

FIG. 10 is a block diagram representing an electric circuit of the liquid ejection apparatus;

FIG. 11 is a graph representing the relationship between the absorption rate of dispersion medium and the wavelength of laser;

FIG. 12 is a graph representing the relationship between the absorption rate of manganese particles and the wavelength of laser;

FIG. 13 is a timing chart representing operational timings of a piezoelectric element and those of a semiconductor laser;

FIG. 14 is a side view schematically showing a liquid ejection head according to a second embodiment of the present invention;

FIG. 15 is a side view schematically showing operation of the liquid ejection head;

FIG. 16 is a block diagram representing an electric circuit of the liquid ejection apparatus; and

FIG. 17 is a timing chart representing the position of a slider and operational timings of a drive motor.

### DETAILED DESCRIPTION OF THE PREFERRED EMBODIMENTS

First Embodiment

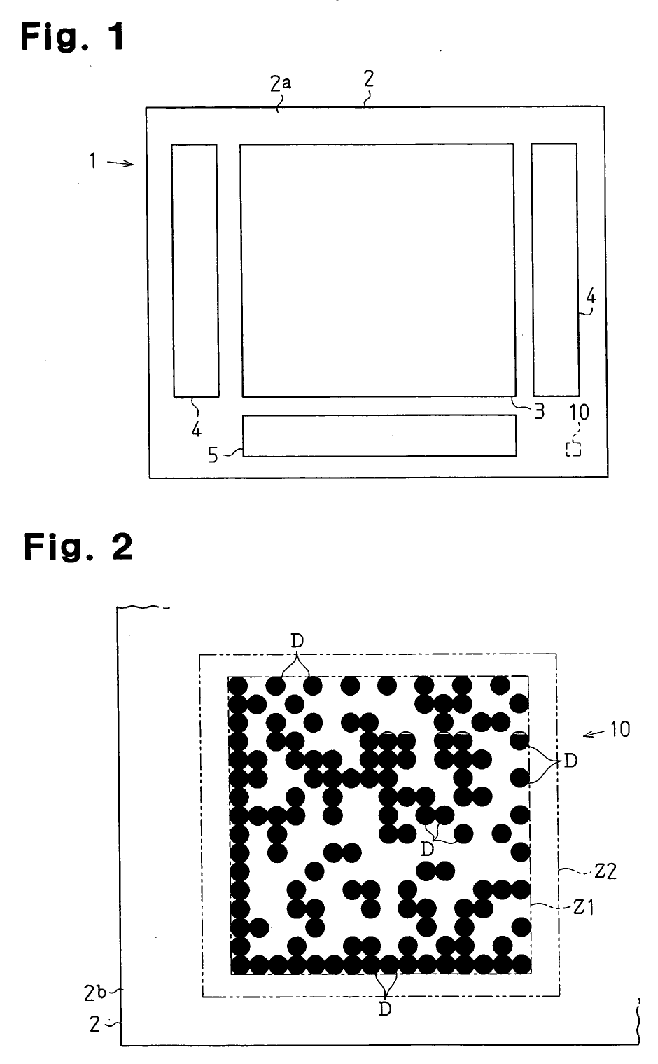

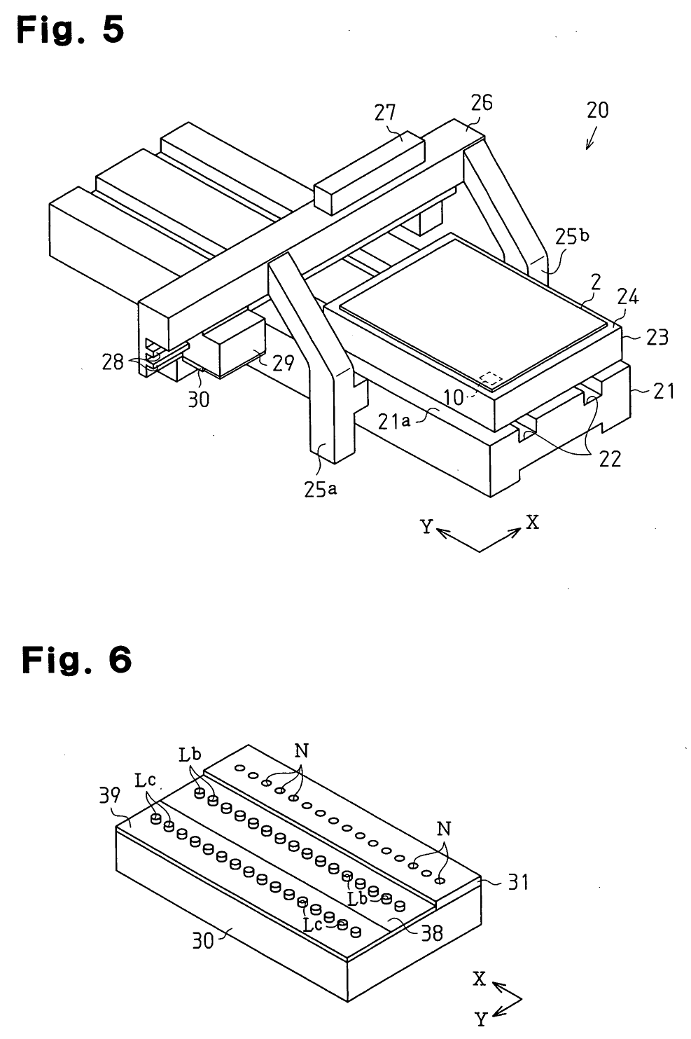

A method for forming an identification code 10 on a display module of a liquid crystal display according to a first embodiment of the present invention will now be described with reference to FIGS. 1 to 13. Directions X, Y in the following description are defined as indicated by the corresponding arrows of FIG. 5.

As shown in FIG. 1, a liquid crystal display module 1 includes a transparent glass substrate 2 (hereinafter, referred to as a substrate 2) serving as a light-transmittable display substrate. A rectangular display portion 3 is formed substantially in the center of a surface 2a of the substrate 2. Liquid crystal molecules are sealed in the display portion 3. A scanning line driver circuit 4 and a data line driver circuit 5 are arranged outside the display portion 3. The scanning line driver circuit 4 generates a scanning signal and the data line driver circuit 5 generates a data signal. In correspondence with the signals, the liquid crystal display module 1 controls the orientations of the liquid crystal molecules. The liquid crystal display module 1 modulates area light emitted by a non-illustrated illumination device in accordance with the orientations of the liquid crystal molecules. In this manner, an image is displayed on the display portion 3.

An identification code 10 of the liquid crystal display module 1 is formed in a bottom right corner of a backside 2b of the substrate 2 as viewed in FIG. 1. Referring to FIG. 2, the identification code 10 is formed by a plurality of dots D. The dots D are provided in a dot formation area Z1 in accordance with a predetermined pattern.

A rectangular blank area Z2 is defined around the outer circumference of the dot formation area Z1 on the backside 2b of the substrate 2. In the first embodiment, the identification code 10 in the dot formation area Z1 is defined by a two-dimensional code and thus readable by a two-dimensional code reader. The blank area Z2 is an empty area in which the dots D are not formed. The blank area X2 thus prevents erroneous detection of the identification code 10, which is contained in the dot formation area Z1.

As shown in FIG. 4, the dot formation area Z1 has a square shape each side of which is 1 to 2 millimeters. The dot formation area Z1 is thus virtually divided into 256 cells aligned by 16 rows×16 columns. The identification code 10 of the liquid crystal display module 1 is defined by the dots D that are provided in selected ones of the cells C.

In the first embodiment, each of the cells C in which the dot D is formed is defined as a black cell C1 (a dot section). Each of the empty cells C is defined as a blank cell C0 (a non-dot section). Referring to FIG. 4, the rows of the cells C are sequentially numbered from up to down as a first row to a sixteenth row, as viewed in the drawing. The columns of the cells C are sequentially numbered from the left to the right as a first column to a sixteenth column, as viewed in FIG. 4.

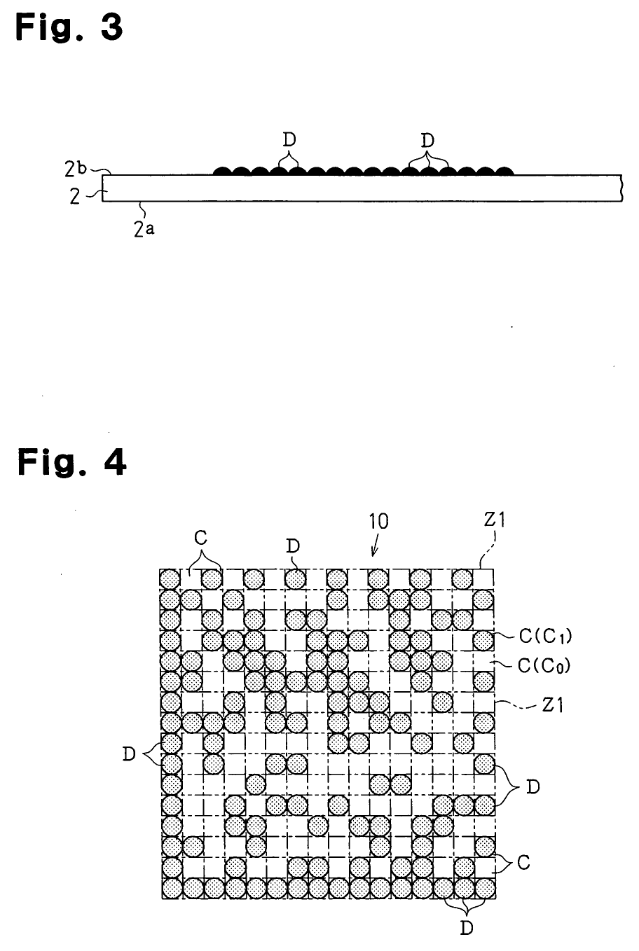

With reference to FIGS. 2 and 3, each of the dots D is securely bonded with the substrate 2 and has a semispherical shape. The dots D are provided by the inkjet method. More specifically, a droplet Fb containing dot forming material (for example, manganese particles) is ejected onto the corresponding cell C through a nozzle N, which is defined in a liquid ejection apparatus 20 of FIG. 8. The droplet Fb is then dried in the cell C and the manganese particles in the droplet Fb are baked, thus forming the dot D. Such drying and baking of the droplet Fb are performed by radiating laser beams onto the droplet Fb that has been received by the substrate 2.

As shown in FIG. 5, the liquid ejection apparatus 20 includes a parallelepiped base 21. A pair of guide grooves 22 are defined in an upper surface 21a of the base 21 and extend in direction Y. A substrate stage 23 is secured to the upper side of the base 21. The substrate stage 23 has a linear movement mechanism (not shown) formed by threaded shafts (drive shafts) extending along the guide grooves 22 and ball nuts engaged with the threaded shafts. The threaded shafts are connected to a y-axis motor MY (see FIG. 10), which is, for example a stepping motor. In response to a drive signal corresponding to a predetermined number of steps, the y-axis motor MY is rotated in a forward direction or a reverse direction. This reciprocates the substrate stage 23 at a predetermined speed along direction Y. In the first embodiment, the position of the substrate stage 23 of FIG. 5 is defined as an initial position.

The upper surface of the substrate stage 23 forms a mounting surface 24 having a suction type substrate chuck mechanism (not shown). The substrate 2 is mounted on the mounting surface 24 with the backside 2b facing upward. In this state, the substrate chuck mechanism operates to position and fix the substrate 2 at a predetermined position on the mounting surface 24. More specifically, the substrate 2 is arranged on the mounting surface 24 in such a manner that the columns of the cells C extend along direction Y with the first row of the cells C located foremost in direction Y.

A pair of supports 25a, 25b are arranged at opposing sides of the base 21 and extend upward. A guide member 26 is secured to the upper ends of the supports 25a, 25b and extends along direction X. The longitudinal dimension of the guide member 26 is greater than the width of the substrate stage 23. An end of the guide member 26 projects outwardly with respect to the support 25a.

A reservoir 27 is mounted on the upper side of the guide member 26 and retains liquid Fa (see FIG. 8). The liquid Fa is prepared by dispersing manganese particles, which are functional particles, in a dispersion medium. A pair of guide rails 28 are formed along the lower side of the guide member 26 and extend along direction X. A carriage 29 is movably supported by the guide rails 28 and includes a linear movement mechanism (not shown) formed by a threaded shaft (a drive shaft) and a ball nut. The threaded shaft of the mechanism extends along the guide rails 28 and the ball nut is engaged with the threaded shaft. The threaded shaft is connected to an x-axis motor MX (see FIG. 10). In response to a prescribed pulse signal, the x-axis motor MX is rotated in a forward direction or a reverse direction in accordance with a corresponding number of steps. In other words, in response to a drive signal corresponding to a predetermined number of steps, the x-axis motor MX is rotated in the forward or reverse direction, thus reciprocating the carriage 29 along direction X.

The ejection head 30, or liquid ejection means, is secured to a lower portion of the carriage 29. Referring to FIG. 6, a nozzle plate 31 is secured to a lower surface (an upper surface as viewed in the drawing) of the ejection head 30. Sixteen nozzles N, or ejection ports, are defined in the nozzle plate 31. The nozzles N are aligned in a single row as equally spaced in direction X.

As shown in FIG. 8, cavities 32, or pressure chambers, are defined in the ejection head 30. The cavities 32 communicate with the reservoir 27 (FIG. 5). The liquid Fa is thus introduced from the reservoir 27 into each of the cavities 32 and then ejected through the corresponding one of the nozzles N. An oscillation plate 33 and a piezoelectric element 34 are provided above each cavity 32. When the ejection head 30 receives a drive signal for any piezoelectric element 34 (piezoelectric element drive voltage VDP), the piezoelectric element 34 flexibly deforms in a vertical direction. This oscillates the associated oscillation plate 33 vertically and thus selectively increases or decreases the volume of the corresponding cavity 32. Accordingly, the liquid Fa is ejected as the droplet Fb by an amount corresponding to the reduced volume of the cavity 32.

As shown in FIG. 6, a drying laser radiation device 38 is secured to a lower portion of the carriage 29 at a position adjacent to the ejection head 30. A baking laser radiation device 39 is arranged adjacent to the drying laser radiation device 38. The drying laser radiation device 38 is located closer to the nozzles N than the baking laser radiation device 39. The drying laser radiation device 38 includes sixteen first semiconductor lasers Lb, or first laser radiating portions, in correspondence with the nozzles N. The first semiconductor lasers Lb are aligned in a single row as equally spaced in direction X. When the droplets Fb are ejected through the corresponding nozzles N and received by the substrate 2, the corresponding first semiconductor lasers Lb radiate laser beams.

The row of the first semiconductor lasers Lb is arranged parallel with the row of the nozzles N. The first semiconductor lasers Lb are spaced from the corresponding nozzles N by uniform distances.

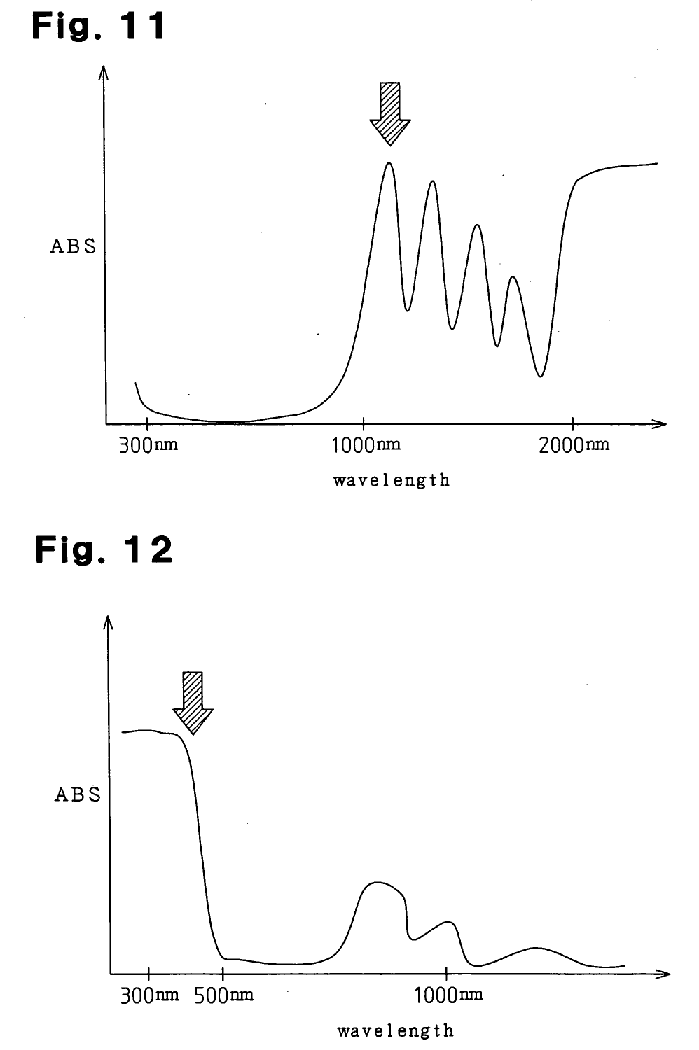

The wavelength of the laser beam radiated by each first semiconductor laser Lb is set in correspondence with the absorption coefficient of the dispersion medium of the liquid Fa. The dispersion medium of the liquid Fa has the absorption wavelength shown in FIG. 11. Thus, each first semiconductor laser Lb radiates a laser beam having a first wavelength (1000 to 1200 nanometers), which is indicated by the arrow of the graph.

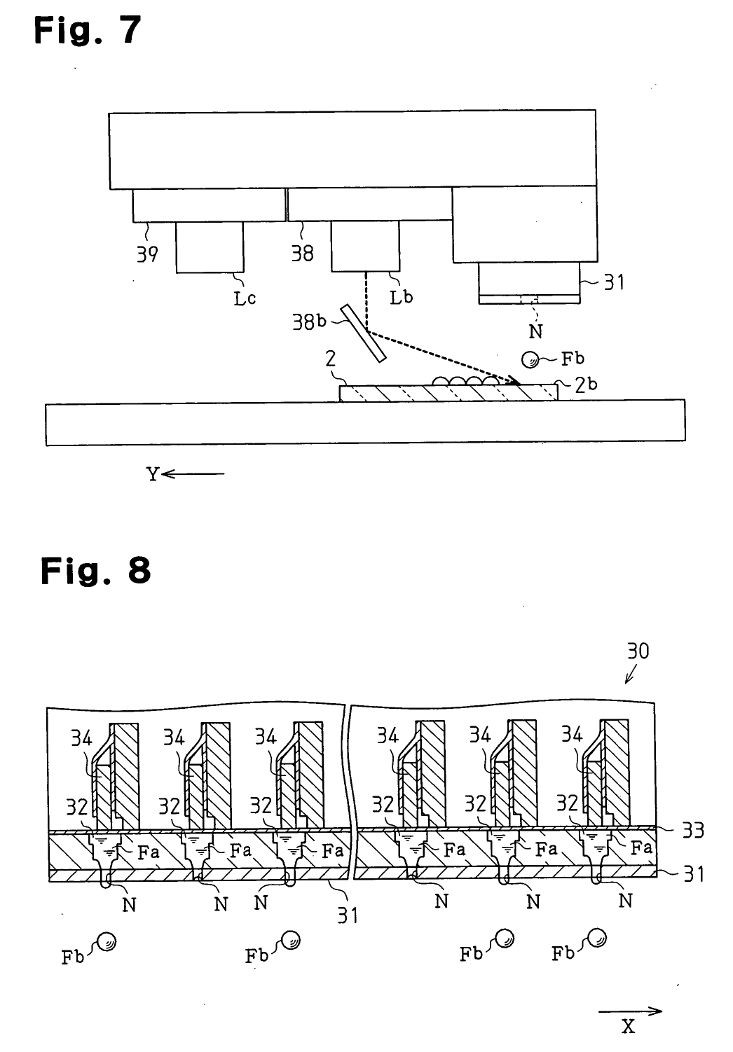

As shown in FIG. 7, a reflective mirror 38b is arranged below the drying laser radiation device 38. The reflective mirror 38b sends the laser beams of the first semiconductor lasers Lb to positions immediately below the nozzles N, or positions defined on the substrate 2 in correspondence with the nozzles N. Thus, the laser beams radiated by the drying laser radiation device 38 quickly dry the droplets Fb that have been received by the substrate 2.

The baking laser radiation device 39 includes sixteen second semiconductor lasers Lc, or second laser radiating portions, in correspondence with the nozzles N. The second semiconductor lasers Lc are aligned in a single row as equally spaced in direction X. When the droplets Fb are ejected through the corresponding nozzles N and received by the substrate 2, the corresponding second semiconductor lasers Lc radiate laser beams. This bakes the manganese particles contained in the droplets Fb.

The row of the second semiconductor lasers Lc is arranged parallel with the row of the nozzles N. The second semiconductor lasers Lc are spaced from the corresponding nozzles N by uniform distances.

The wavelength of the laser beam radiated by each second semiconductor laser Lc is set in correspondence with the absorption coefficient of the manganese particles. The manganese particles of the liquid Fa have the absorption wavelength shown in FIG. 12. Thus, each second semiconductor laser Lc radiates a laser beam having a second wavelength (400 to 500 nanometers), which is indicated by the arrow of the graph.

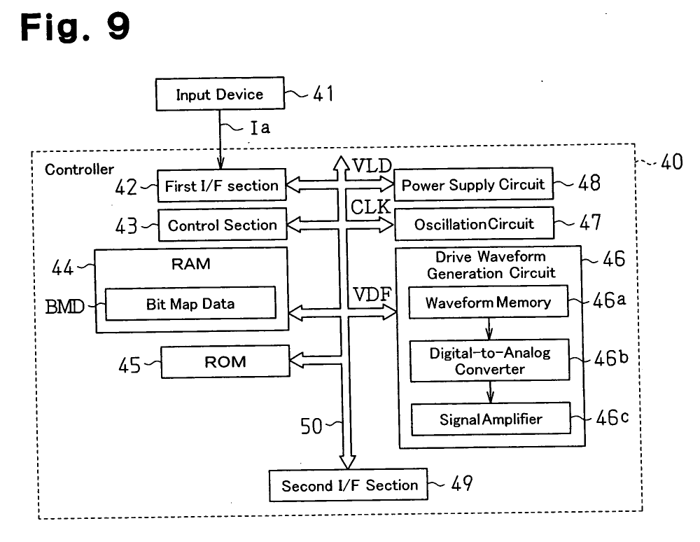

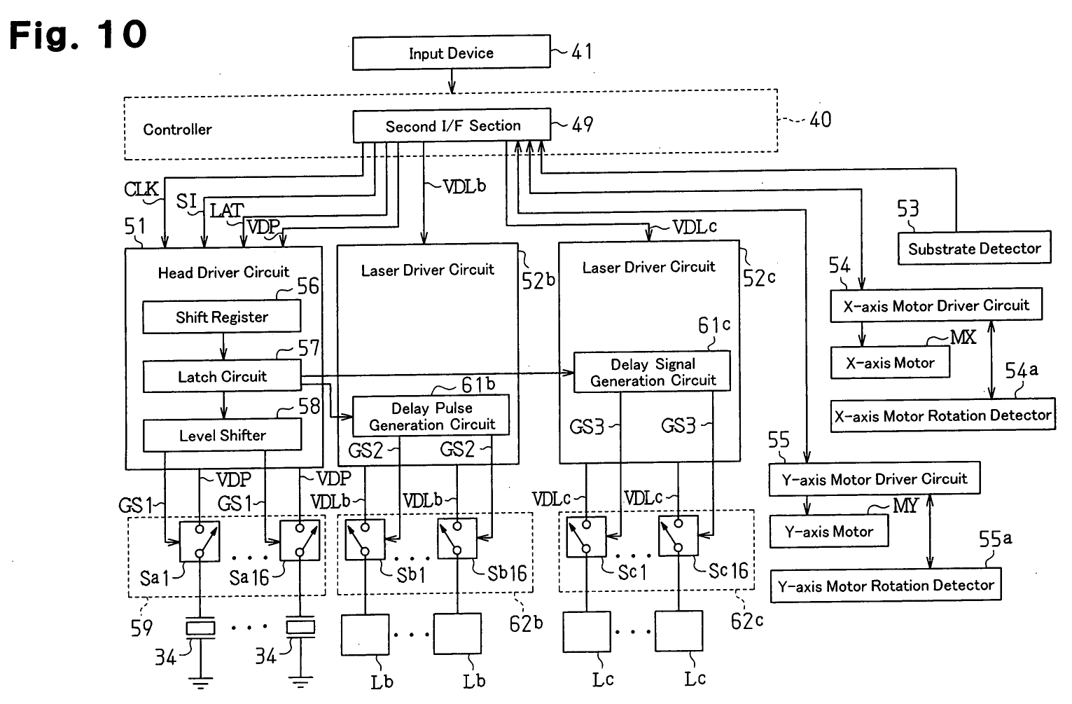

The electric circuit of the liquid ejection apparatus 20 will hereafter be explained with reference to FIGS. 9 and 10.

As shown in FIG. 9, a controller 40 has a first I/F section 42, a control section 43 including a CPU, a RAM 44, and a ROM 45. The first I/F section 42 receives various data from an input device 41, which is formed by, for example, an external computer. The RAM 44 stores various data and the ROM 45 stores different control programs. The controller 40 also includes a drive waveform generation circuit 46, an oscillation circuit 47, the power supply circuit 48, and a second I/F section 49. The oscillation circuit 47 generates a clock signal CLK for synchronizing different drive signals. The power supply circuit 48 generates laser drive voltage VDLb for driving the first semiconductor lasers Lb and laser drive voltage VDLc for driving the second semiconductor lasers Lc. In the controller 40, the first I/F section 42, the control section 43, the RAM 44, the ROM 45, the drive waveform generation circuit 46, the oscillation circuit 47, the power supply circuit 48, and the second I/F section 49 are connected together through a bus 50.

The first I/F section 42 receives code formation data Ia representing an image of the identification code 10. The identification code 10 is defined as a two-dimensional code formed by a known method and represents identification data regarding the product number or the lot number of the substrate 2.

In correspondence with the code formation data Ia received by the first I/F section 42, the control section 43 performs an identification code formation procedure. That is, the control section 43 executes a control program (for example, an identification code formation program) stored in the ROM 45 using the RAM 44 as a processing area. In accordance with the program, the control section 43 carries out a transport procedure for transporting the substrate 2 by moving the substrate stage 23 and a droplet ejection procedure by exciting the piezoelectric elements 34 of the ejection head 30. Further, in accordance with the identification code formation program, the control section 43 drives the first semiconductor lasers Lb and thus performs a drying procedure for drying the droplets Fb.

More specifically, the control section 43 performs a prescribed development procedure on the code formation data Ia received by the first I/F section 42. This produces bit map data BMD that indicates whether or not the droplets Fb must be ejected onto the cells C that are defined on a two-dimensional code formation plane (the dot formation area Z1). The bit map data BMD is then stored in the RAM 44. The bit map data BMD is defined by serial data that has a bit length of 16×16 bits in correspondence with the piezoelectric elements 34. That is, in accordance with the value (0 or 1) of each bit, the corresponding piezoelectric element 34 is excited or de-excited.

The control section 43 performs an additional development procedure, which is different from the development procedure corresponding to the bit map data BMD, on the code formation data Ia. This produces waveform data for the piezoelectric element drive voltage VDP that is supplied to each of the piezoelectric elements 34. The waveform data is then output to the drive waveform generation circuit 46. The drive waveform generation circuit 46 has a waveform memory 46a, a digital-to-analog converter section 46b, and a signal amplifier 46c. The waveform memory 46a stores the waveform data. The digital-to-analog converter section 46b converts the waveform data into an analog signal. The signal amplifier 46c amplifies the analog signal. Thus, the drive waveform generation circuit 46 converts the waveform data stored in the waveform memory 46a into the analog signal by means of the digital-to-analog converter section 46b. The analog signal is then amplified by the signal amplifier 46c and thus the piezoelectric element drive voltage VDP is generated.

Referring to FIG. 10, the control section 43 serially transports an ejection control signal SI to a head driver circuit 51 (a shift register 56) through the second I/F section 49. The ejection control signal SI is produced by synchronizing the bit map data BMD with the clock signal CLK generated by the oscillation circuit 47. The control section 43 also sends a latch signal LAT to the head driver circuit 51 for latching the ejection control signal SI. Further, the control section 43 outputs the piezoelectric element drive voltage VDP to the head driver circuit 51 (switch elements Sa1 to Sa16) synchronously with the clock signal CLK.

The head driver circuit 51, a laser driver circuit 52b, a laser driver circuit 52c, a substrate detector 53, an x-axis motor driver circuit 54, and a y-axis motor driver circuit 55 are connected to the controller 40 via the second I/F section 49. The laser driver circuit 52b drives the first semiconductor lasers Lb and the laser driver circuit 52c drives the second semiconductor lasers Lc.

The head driver circuit 51 has the shift register 56, a latch circuit 57, a level shifter 58, and a switch circuit 59. The shift register 56 converts the ejection control signal SI, which has been serially transported from the controller 40 (the control section 43), to a parallel signal in correspondence with the sixteen piezoelectric elements 34. The latch circuit 57 latches the parallel 16-bit ejection control signal SI synchronously with the latch signal LAT. The latched ejection control signal SI is then output to the level shifter 58 and the laser driver circuits 52b, 52c. The level shifter 58 raises the voltage of the latched ejection control signal SI to the drive voltage of the switch circuit 59. In this manner, an open-close signal GS1 is generated in correspondence with each of the piezoelectric elements 34. The switch circuit 59 includes switch elements Sa1 to Sa16 in correspondence with the piezoelectric elements 34. The piezoelectric drive voltage VDP is supplied commonly to the inputs of the switch elements Sa1 to Sa16. The outputs of the switch elements Sa1 to Sa16 are connected to the corresponding piezoelectric elements 34. Each switch element Sa1 to Sa16 receives the corresponding open-close signal GS1 from the level shifter 58. In correspondence with the open-close signal GS1, it is determined whether or not the piezoelectric element drive voltage VDP should be supplied to the corresponding piezoelectric element 34.

In the first embodiment, the common piezoelectric drive voltage VDP is supplied to the piezoelectric elements 34 through the corresponding switch elements Sa1 to Sa16. Further, operation of each switch element Sa1 to Sa16 is controlled in correspondence with the ejection control signal SI (the open-close signal GS1). When the switch element Sa1 to Sa16 is closed, the piezoelectric drive voltage VDP is supplied to the corresponding piezoelectric element 34. The droplet Fb is thus ejected from the nozzle N corresponding to the piezoelectric element 34.

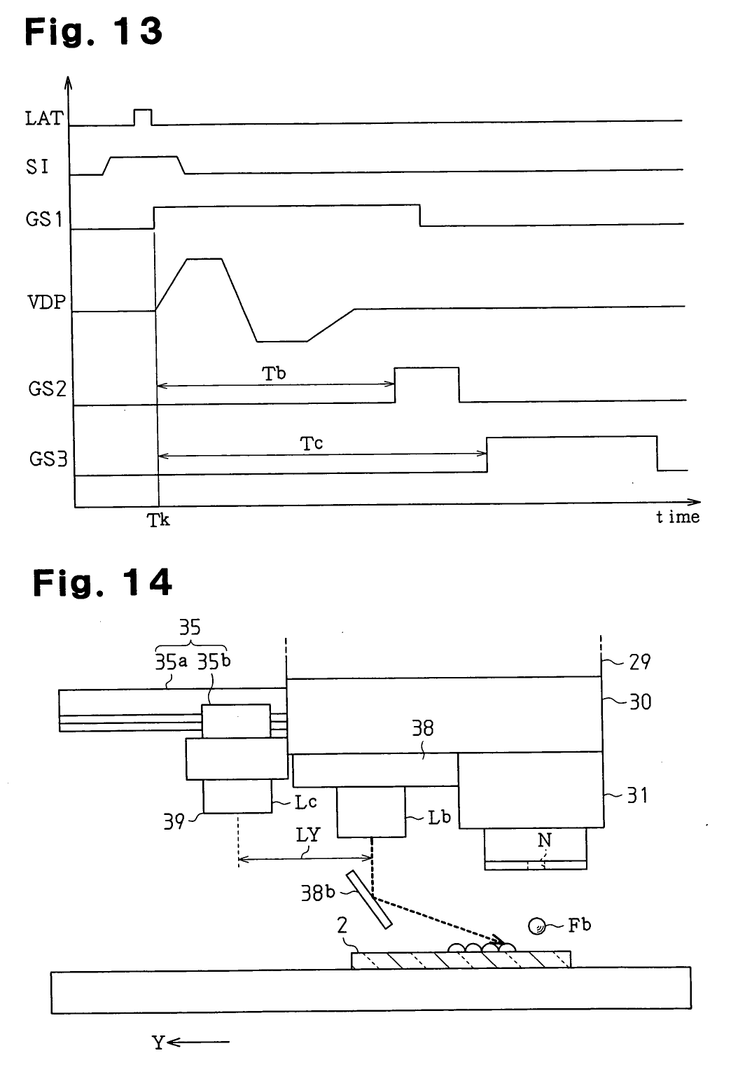

FIG. 13 shows the pulse waveforms of the latch signal LAT, the ejection control signal SI, and the open-close signal GS1 and the waveform of the piezoelectric drive voltage VDP, which is supplied to the corresponding piezoelectric element 34 in response to the open-close signal GS1.

Referring to FIG. 13, in response to the fall of the latch signal LAT, the open-close signal GS1 is produced in correspondence with the 16-bit ejection control signal SI. Then, in response to the rise of the open-close signal GS1, the piezoelectric element 34 corresponding to the open-close signal GS1 is supplied with the piezoelectric element drive voltage VDP. As the piezoelectric element drive voltage VDP increases, the piezoelectric element 34 contracts. The liquid Fa is thus introduced into the corresponding cavity 32. Subsequently, as the piezoelectric element drive voltage VDP decreases, the piezoelectric element 34 extends. This causes the liquid Fa to flow from the cavity 32 and thus be ejected as the droplet Fb. The piezoelectric element drive voltage VDP then restores the initial value, thus completing the ejection of the droplet Fb.

As shown in FIG. 10, the laser driver circuit 52b has a delay pulse generation circuit 61b and a switch circuit 62b. The delay pulse generation circuit 61b generates a pulse signal (an open-close signal GS2) by delaying the latched ejection control signal SI by a predetermined time (standby time Tb). The open-close signal GS2 is then output to the switch circuit 62b. The standby time Tb is defined as the time from a reference point Tk, or when excitement of the piezoelectric element 34 is started (in response to the fall of the latch signal LAT), to when the corresponding droplet Fb reaches the position on the substrate 2 at which the laser beam radiated by the corresponding first semiconductor laser Lb is received by the substrate 2, or a laser radiating position of the first semiconductor laser Lb. That is, the standby time Tb is a predetermined value obtained by tests and defined as the time from when liquid ejection through the excitement of the piezoelectric element 34 is started (in response to the supply of the electric element drive voltage VDP) to when the droplet Fb that has been received by the substrate 2 reaches the laser radiating position of the corresponding first semiconductor laser Lb.

The switch circuit 62b includes switch elements Sb1 to Sb16 in correspondence with the first semiconductor lasers Lb. The laser drive voltage VDLb is supplied commonly to the inputs of the switch elements Sb1 to Sb16. The outputs of the switch elements Sb1 to Sb16 are connected to the corresponding semiconductor lasers Lb. Each switch element Sb1 to Sb16 receives the corresponding open-close signal GS2 from the delay pulse generation circuit 61b. In correspondence with the open-close signal GS2, it is determined whether or not the laser drive voltage VDLb should be supplied to the corresponding first semiconductor laser Lb.

In this manner, the liquid ejection apparatus 20 supplies the laser drive voltage VDLb, which has been generated by the power supply circuit 48, commonly to the first semiconductor lasers Lb through the corresponding switch elements Sb1 to Sb16. Further, operation of each of the switch elements Sb1 to Sb16 is controlled in correspondence with the ejection control signal SI (the open-close signal GS2) provided by the controller 40 (the control section 43). When the switch element Sb1 to Sb16 is closed, the corresponding first semiconductor laser Lb is supplied with the laser drive voltage VDLb and thus radiates a laser beam.

In other words, referring to FIG. 13, the open-close signal GS2 is output after the standby time Tb has elapsed following input of the latch signal LAT to the head driver circuit 51. In response to the rise of the open-close signal GS2, supply of the laser drive voltage VDLb to the corresponding first semiconductor laser Lb is started. This causes the first semiconductor laser Lb to radiate the laser beam. Accordingly, when each droplet Fb that has been received by the substrate 2 reaches and moves along the laser radiating position of the corresponding first semiconductor laser Lb, the first semiconductor laser Lb is allowed to radiate the laser beam onto the droplet Fb at an optimal timing. Afterwards, the open-close signals GS2 fall and thus the supply of the laser drive voltage VDLb stops. The drying procedure by means of the first semiconductor lasers Lb is thus ended.

The laser driver circuit 52c has a delay signal generation circuit 61c and a switch circuit 62c. The delay signal generation circuit 61c generates a signal (an open-close signal GS3) by delaying the latched ejection control signal SI by a predetermined time (standby time Tc). The open-close signal GS2 is then output to the switch circuit 62c. The standby time Tc is defined as the time from the reference point Tk, or when the excitement of the piezoelectric element 34 is started (in response to the fall of the latch signal LAT), to when the droplet Fb reaches the position immediately below the corresponding second semiconductor laser Lc (the laser radiating position of the second semiconductor laser Lc). That is, the standby time Tc is a predetermined value obtained by a test and defined as the time from when the liquid ejection through the excitement of the piezoelectric element 34 is started (in response to the supply of the electric element drive voltage VDP) to when the droplet Fb that has been received by the substrate 2 reaches the laser radiating position of the corresponding second semiconductor laser Lc.

The switch circuit 62c includes switch elements Sc1 to Sc16 in correspondence with the second semiconductor lasers Lc. The laser drive voltage VDLc is supplied commonly to the inputs of the switch elements Sc1 to Sc16. The outputs of the switch elements Sc1 to Sc16 are connected to the corresponding second semiconductor lasers Lc. Each switch element Sc1 to Sc16 receives the corresponding open-close signal GS3 from the delay signal generation circuit 61c. In correspondence with the open-close signal GS3, it is determined whether or not the laser drive voltage VDLc should be supplied to the corresponding second semiconductor laser Lc.

In this manner, the liquid ejection apparatus 20 supplies the laser drive voltage VDLc, which has been generated by the power supply circuit 48, commonly to the second semiconductor lasers Lc through the corresponding switch elements Sc1 to Sc16. Further, operation of each of the switch elements Sc1 to Sc16 is controlled in correspondence with the ejection control signal SI (the open-close signal GS3) provided by the controller 40 (the control section 43). When the switch element Sc1 to Sc16 is closed, the corresponding second semiconductor laser Lc is supplied with the laser drive voltage VDLc and thus radiates a laser beam.

In other words, referring to FIG. 13, the open-close signal GS3 is output after the standby time Tc has elapsed following input of the latch signal LAT to the head driver circuit 51. In response to the rise of the open-close signal GS3, supply the laser drive voltage VDLc to the corresponding second semiconductor laser Lc is started. This causes the second semiconductor laser Lc to radiate the laser beam. Accordingly, when each droplet Fb that has been received by the substrate 2 reaches and moves along the laser radiating position of the corresponding second semiconductor laser Lc, the second semiconductor laser Lc is allowed to radiate the laser beam onto the droplet Fb at an optimal timing. Afterwards, the open-close signals GS3 fall and thus the supply of the laser drive voltage VDLc stops. The baking procedure by means of the second semiconductor lasers Lc is thus ended.

The controller 40 is connected to the substrate detector 53 through the second I/F section 49. The controller 40 detects an end of the substrate 2 that faces in direction Y by means of the substrate detector 53. In correspondence with such detection result, the controller 40 calculates the position of the substrate 2 passing immediately below the ejection head 30 (the nozzle N).

The controller 40 is connected to the x-axis motor driver circuit 54 through the second I/F section 49. The controller 40 sends an x-axis motor drive signal to the x-axis motor driver circuit 54. In response to the x-axis motor drive signal, the x-axis motor driver circuit 54 generates a signal for rotating the x-axis motor MX in the forward or reverse direction. Through such rotation of the x-axis motor MX, the carriage 29 is reciprocated along direction X at a predetermined speed.

The controller 40 is connected to an x-axis motor rotation detector 54a through the x-axis motor driver circuit 54. In correspondence with a detection signal of the x-axis motor rotation detector 54a, the controller 40 detects the rotational direction and the rotational amount of the x-axis motor MX. Based on such detection results, the controller 40 calculates the movement direction and the movement amount of the carriage 29.

The controller 40 is connected to the y-axis motor driver circuit 55 through the second I/F section 49. The controller 40 sends a y-axis motor drive signal to the y-axis motor driver circuit 55. In response to the y-axis motor drive signal, the y-axis motor driver circuit 55 generates a signal for rotating the y-axis motor MY in the forward or reverse direction. Through such rotation of the y-axis motor MY, the substrate stage 23 is reciprocated along direction Y at a predetermined speed.

The controller 40 is connected to a y-axis motor rotation detector 55a through the y-axis motor driver circuit 55. In correspondence with a detection signal of the y-axis motor rotation detector 55a, the controller 40 detects the rotational direction and the rotational amount of the y-axis motor MY. Based on such detection results, the controller 40 calculates the movement direction and the movement amount of the substrate 2.

A method for forming the identification code 10 will hereafter be explained.

First, as shown in FIG. 5, the substrate 2 is mounted on and fixed to the substrate stage 23 with the backside 2b facing upward. In this state, the end of the substrate 2 that faces in direction Y is located rearward from the guide member 26 in direction Y. The carriage 29 is set in such a manner that the identification code 10 (the dot formation area Z1) passes immediately below the ejection head 30 when the substrate 2 moves along direction Y.

The controller 40 then operates the y-axis motor MY to transport the substrate 2 mounted on the substrate stage 23 at a predetermined speed. When the substrate detector 53 detects the end of the substrate 2 facing in direction Y, the controller 40 determines whether or not the first row of the cells C (the black cells C1) has reached the position immediately below the nozzles N, in correspondence with the detection signal of the y-axis motor rotation detector 55a.

At this stage, the controller 40 outputs the ejection control signal SI and supplies the piezoelectric element drive voltage VDP to the head driver circuit 51 in accordance with the identification code formation program. The controller 40 also provides the laser drive voltage VDLb to the laser driver circuit 52b and the laser drive voltage VDLC to the laser driver circuit 52c. The controller 40 then stands by till the latch signal LAT must be sent.

When the first row of the cells C (the black cells C1) reaches the position immediately below the nozzles N (the droplet receiving positions), the controller 40 provides the latch signal LAT to the head driver circuit 51. In response to the latch signal LAT, the head driver circuit 51 generates the open-close signals GS1 in correspondence with the ejection control signal SI. Each open-close signal GS1 is then sent to the switch circuit 59. Further, the head driver circuit 51 supplies the piezoelectric element drive voltage VDP to each of the piezoelectric elements 34 corresponding to the switch elements Sa1 to Sa16 that are held in a closed state. This causes the droplets Fb to be simultaneously ejected from the corresponding nozzles N.

When the head driver circuit 51 receives the latch signal LAT, the laser driver circuit 52b (the delay pulse generation circuit 61b) receives the latched ejection control signal SI from the latch circuit 57 and thus starts generation of the open-close signals GS2. Each open-close signal GS2 is output to the switch circuit 62b after the standby time Tb has elapsed. Further, the laser driver circuit 52b supplies the laser drive voltage VDLb to the first semiconductor lasers Lb corresponding to the switch elements Sb1 to Sb16 that are held in a closed state. The first semiconductor lasers Lb thus simultaneously radiate the laser beams onto the corresponding droplets Fb, which have been received in the black cells C1 of the first row. This evaporates the dispersion medium of the droplets Fb, drying the droplets Fb.

Meanwhile, the laser driver circuit 52c (the delay signal generation circuit 61c) receives the latched ejection control signal SI from the latch circuit 57 and thus starts generation of the open-close signals GS3. Each open-close signal GS3 is output to the switch circuit 62c after the standby time Tc has elapsed. Further, the laser driver circuit 52c supplies the laser drive voltage VDLc to the second semiconductor lasers Lc corresponding to the switch elements Sc1 to Sc16 that are held in a closed state. The second semiconductor lasers Lc thus simultaneously radiate the laser beams onto the corresponding droplets Fb, which have been received in the black cells C1 of the first row. This bakes the manganese particles of the droplets Fb, fixing the droplets Fb to the substrate 2. In this manner, the dot D that is formed of manganese and has a semispherical shape is provided.

Afterwards, in the same manner as has been described, the droplets Fb are ejected from the corresponding nozzles N and then received by the substrate 2. The droplets Fb are then dried by the laser beams radiated by the corresponding first semiconductor lasers Lb. Subsequently, the droplets Fb are transported to the positions immediately below the corresponding semiconductor lasers Lc. At these positions, the droplets Fb are subjected to baking of the manganese particles by the laser beams radiated by the second semiconductor lasers Lc. In this manner, the dots D defining the identification code 10 are formed in accordance with each row, which extend in direction X.

When all of the dots D necessary for defining the identification code 10 are completed, the controller 40 operates the y-axis motor MY to retreat the substrate 2 from below the ejection head 30.

The first embodiment, which is constructed as above-described, has the following advantages.

(1) As shown in FIGS. 11 and 12, the laser wavelength at which the dispersion medium of the droplets Fb is absorbed is different from the laser wavelength at which the manganese particles of the droplets Fb are absorbed. Thus, in the first embodiment, the drying laser radiation device 38 and the baking laser radiation device 39 are arranged independently from each other. Specifically, the liquid ejection head 30 includes the first semiconductor lasers Lb and the second semiconductor lasers Lc, which are provided separately from the first semiconductor lasers Lb. The first semiconductor lasers Lb operate to evaporate the dispersion medium of the droplets Fb. The second semiconductor lasers Lc operate to bake the manganese particles of the droplets Fb. Thus, the laser having the wavelength that absorbs the dispersion medium and the laser having the wavelength that absorbs the manganese particles can be employed separately. This improves efficiency for performing drying and baking on the droplets Fb. Further, the laser beam of each first semiconductor laser Lb is received at a position in the vicinity of the corresponding receiving position of the droplet Fb. This further improves efficiency for drying the droplets Fb.

(2) In the first embodiment, only selected ones of the sixteen first semiconductor lasers Lb and corresponding ones of the sixteen second semiconductor lasers Lc are activated. Thus, laser radiation by the first or second semiconductor lasers Lb, Lc does not occur in the portions of the dot formation area Z1 in which the droplets Fb are not provided. This saves power consumption.

Second Embodiment

A second embodiment of the present invention will hereafter be described with reference to FIGS. 14 to 17.

As shown in FIG. 14, the carriage 29 includes a stage 35, or a mechanism, which is secured to an end of the ejection head 30. The stage 35 includes a slide bar 35a extending in direction Y and a slider 35b movably supported by the slide bar 35a. The baking laser radiation device 39 is secured to a lower portion of the slider 35b. The baking laser radiation device 39 is supported by the stage 35 in a manner movable relative to the carriage 29 and in direction Y.

The drying laser radiation device 38 is secured to the lower surface of the ejection head 30. In the second embodiment, movement of the slider 35b along the slide bar 35a changes the position of the baking laser radiation device 39 relative to the position of the drying laser radiation device 38, or the distance LY between the baking laser radiation device 39 (the second semiconductor lasers Lc) and the drying laser radiation device 38 (the first semiconductor lasers Lb). Accordingly, as measured on the substrate 2, the distance between each laser radiating position of the drying laser radiation device 38 and the corresponding laser radiating position of the baking laser radiation device 39 changes.

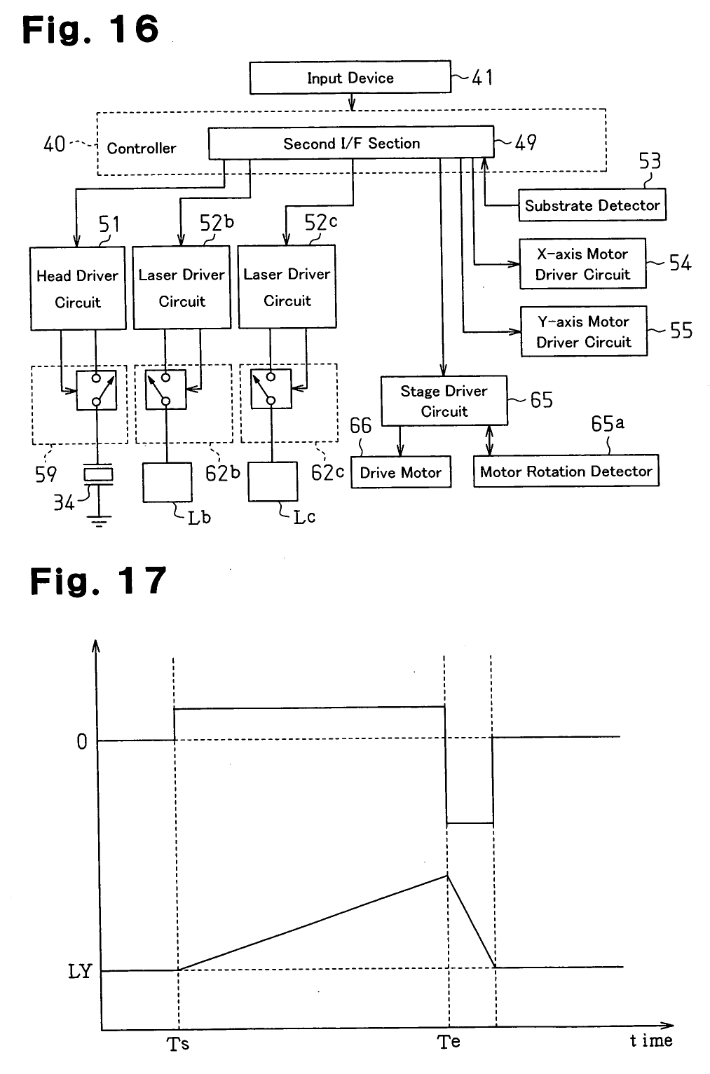

As shown in FIG. 16, the controller 40 is connected to a stage driver circuit 65 through the second I/F section 49. The stage driver circuit 65 is connected to a drive motor 66. The controller 40 sends a stage drive signal to the stage driver circuit 65. The stage drive signal is then input to the drive motor 66. In response to the stage drive signal, the drive motor 66 is rotated in a forward or reverse direction. Through such rotation, the slider 35b is reciprocated along the slide bar 35a, thus reciprocating the baking laser radiation device 39 in direction Y.

The controller 40 is connected to a motor rotation detector 65a through the stage driver circuit 65. In correspondence with a detection signal of the motor rotation detector 65a, the controller 40 detects the rotational direction and the rotational amount of the drive motor 66. Based on such detection results, the controller 40 calculates the movement direction and the movement amount of the slider 35b (the baking laser radiation device 39).

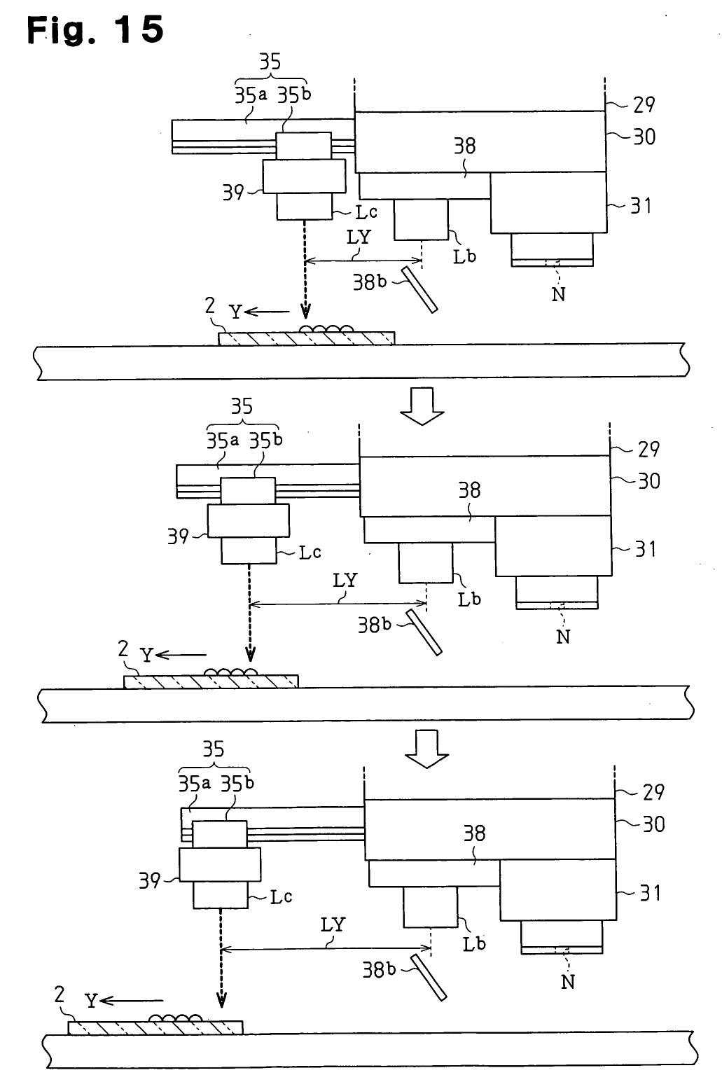

Next, operation of the stage 35 will now be explained with reference to FIGS. 15 and 17.

As shown in FIG. 15, the baking laser radiation device 39 is located at an initial position before laser radiation by the second semiconductor lasers Lc is started. In this state, the distance LY between each first semiconductor laser Lb and the corresponding second semiconductor laser Lc is minimum. The substrate 2 is then moved in direction Y and thus the droplets Fb that have been received by the corresponding cells C of the first row reach the positions immediately below the corresponding second semiconductor lasers Lc (at the point Ts of FIG. 17). At this point, the drive motor 66 starts to rotate. This moves the slider 35b along the slide bar 35a in direction Y. The baking laser radiation device 39 thus starts to move in direction Y.

Such movement of the slider 35b separates the baking laser radiation device 39 from the drying laser radiation device 38. The distance LY between each first semiconductor laser Lb and the corresponding second semiconductor laser Lc thus gradually becomes greater. The movement speed of the slider 35b, which moves in direction Y, is lower than the movement speed of the substrate 2. After the final row of the cells C has left the laser radiating positions of the corresponding second semiconductor lasers Lc (at the point Te of FIG. 17), the drive motor 66 starts to rotate in the reverse direction. This moves the slider 35b along the slide bar 35a in a direction opposed to direction Y. The baking laser radiation device 39 thus moves in the direction opposed to direction Y and returns to the initial position.

The second embodiment has the following advantages.

(3) The baking laser radiation device 39 is supported by the stage 35 in a manner movable relative to the carriage 29. As the substrate 2 moves in direction Y, the baking laser radiation device 39 moves correspondingly. The movement speed of the baking laser radiation device 39 is lower than the movement speed of the substrate 2. This reduces the relative speed between the substrate 2 and the baking laser radiation device 39. The time for radiating the laser beams from the second semiconductors Lc onto the droplets Fb is thus prolonged. Prolonged laser radiation by the second semiconductor lasers Lc promotes baking of the manganese particles contained in the droplets Fb, which normally consumes more energy than drying. In order to increase the speed for forming the identification code 10, the movement speed of the substrate stage 23 needs to be raised so that the laser radiation time of the first semiconductor lasers Lb is decreased. However, as has been described, the laser radiation time of the second semiconductor lasers Lc is ensured to be sufficiently long.

The illustrated embodiments may be modified as follows.

In the second embodiment, the baking laser radiation device 39 is secured to the carriage 29 through the stage 35. However, the baking laser radiation device 39 may be secured to any suitable component other than the carriage 29.

Alternatively, the baking laser radiation device 39 may be fixed to the carriage 29. In this case, a reflective mirror is rotatably provided at a position below the baking laser radiation device 39. As the substrate 2 is moved, the rotational angle of the reflective mirror is changed. The laser radiating positions of the baking laser radiation device 39 are thus adjusted. This prolongs the laser radiation time of the baking laser radiation device 39.

In the illustrated embodiments, the lasers that dry the droplets Fb or bake the manganese particles of the droplets Fb may be changed to any suitable lasers other than the semiconductor lasers Lb, Lc. Further, the wavelength of each laser that dries the droplets Fb or bakes the manganese particles of the droplets Fb may be different from the wavelength of the embodiments. However, it is preferred that the wavelength of each laser be set to a value at which the dispersion medium or the metal particles of the droplets Fb is easily absorbed.

In the illustrated embodiments, the laser radiating position of each first semiconductor laser Lb substantially coincides with the corresponding receiving position of the droplet Fb. However, the laser radiating position may be spaced from the droplet receiving position.

Although each of the dots D has the semispherical shape in the illustrated embodiments, the shape of the dot D may be modified as necessary. For example, each dot D may have an oval shape or a linear shape defining a bar code, as viewed from above.

In the illustrated embodiments, the identification code 10 may be changed to a bar code, a character, a numeral, or a mark.

In the illustrated embodiments, the substrate 2 may be replaced by a silicone wafer, a resin film, or a metal plate.

In the illustrated embodiments, pressurization of the cavities 32, which causes ejection of the droplets Fb, may be performed by any suitable structure other than the piezoelectric elements 34. For example, the cavities 32 may be pressurized by generating and bursting bubbles in the cavities 32.

In the illustrated embodiments, each open-close signal GS2 is output by the delay pulse generation circuit 61b of the laser driver circuit 52b after the standby time Tb has elapsed. Each open-close signal GS3 is output by the delay signal generation circuit 61c of the laser driver circuit 52c after the standby time Tc has elapsed. Instead of this, the controller 40 may measure each of the standby times Tb, Tc. After the standby time Tb, Tc has elapsed, the controller 40 provides a control signal to the corresponding laser driver circuit 52b, 52c. In response to the control signal, the laser driver circuit 52b, 52c generates the open-close signal GS2, GS3 in correspondence with the ejection control signal SI, which has been received from the latch circuit 57. The open-close signal GS2, GS3 is then output.

In the illustrated embodiments, the liquid ejection apparatus 20 may be a liquid ejection apparatus that forms an insulating film or a metal wiring. That is, for example, the apparatus 20 may be used for ejecting droplets of liquid containing wiring material onto a substrate. Also in these cases, drying and baking can be efficiently performed on the insulating film or the metal wiring.

In the illustrated embodiments, the liquid crystal display module 1 may be changed to a display module of, for example, an organic electroluminescence display or a field effect type device (FED or SED). The field effect type device has a flat electron emission element that emits electrons. The device emits light from a fluorescent substance by means of the electrons. Further, the substrate 2 on which the identification code 10 is formed may be used in any suitable electronic devices other than the displays.

The present examples and embodiments are to be considered as illustrative and not restrictive and the invention is not to be limited to the details given herein, but may be modified within the scope and equivalence of the appended claims.

1. A liquid ejection apparatus ejecting a liquid containing a functional material onto a substrate through an ejection port as a droplet, the apparatus comprising:
a first laser radiating portion that radiates a laser beam so as to dry the droplet that has been received by the substrate; and
a second laser radiating portion that radiates a laser beam so as to bake the dried droplet.

2. The apparatus according to claim 1, further comprising a base and a substrate stage that supports the substrate in a manner movable relative to the base, wherein laser radiation by each of the first and second laser radiating portions is performed in correspondence with the position of the substrate relative to the base.

3. The apparatus according to claim 2, further comprising
a liquid ejection head that includes the ejection port, and a carriage that supports the liquid ejection head in a manner movable relative to the base, wherein both of the first and second laser radiating portions are secured to the carriage.

4. The apparatus according to claim 3, wherein the liquid ejection head, the first laser radiating portion, and the second laser radiating portion are adjacently arranged.

5. The apparatus according to claim 4, wherein the first laser radiating portion is located closer to the liquid ejection head than to the second laser radiating portion.

6. A liquid ejection apparatus ejecting a liquid containing a functional material onto a substrate through a plurality of ejection ports as droplets, the apparatus comprising:
a first laser radiating portion that radiates laser beams so as to dry the droplets that have been received by the substrate, and a second laser radiating portion that radiates laser beams so as to bake the dried droplets,
wherein the first laser radiating portion includes a plurality of first semiconductor lasers that are provided in correspondence with the ejection ports, and wherein the second laser radiating portion includes a plurality of second semiconductor lasers that are provided in correspondence with the ejection ports.

7. The apparatus according to claim 6,
wherein the ejection ports are aligned in a single row and equally spaced in a direction perpendicular to a movement direction of the substrate, the first semiconductor lasers are aligned in a single row and equally spaced in a direction perpendicular to the movement direction of the substrate, and the second semiconductor lasers are aligned in a single row and equally spaced in a direction perpendicular to the movement direction of the substrate.

8. The apparatus according to claim 6, further comprising a base and a substrate stage that supports the substrate in a manner movable relative to the base, wherein laser radiation by each of the first and second laser radiating portions is performed in correspondence with the position of the substrate relative to the base.

9. The apparatus according to claim 8, further comprising
a liquid ejection head that includes the ejection ports, and a carriage that supports the liquid ejection head in a manner movable relative to the base, wherein both of the first and second laser radiating portions are secured to the carriage.

10. The apparatus according to claim 9, further comprising: a movement mechanism that changes the distance between a laser radiating position of the first laser radiating portion and a laser radiating position of the second laser radiating portion; and a controller that controls operation of the movement mechanism, wherein the controller controls the operation of the movement mechanism in correspondence with the relative position of the laser radiating position of the first laser radiating portion and the base.

11. The apparatus according to claim 10, wherein the movement mechanism changes the distance between the first laser radiating portion and the second laser radiating portion.

12. The apparatus according to claim 10,
wherein the movement mechanism includes a slide bar extending from the carriage in the movement direction of the substrate and a slider movably supported by the slide bar, the first laser radiating portion is secured to the carriage, and the second laser radiating portion is secured to the slider.

13. The apparatus according to claim 12, wherein the controller controls the operation of the movement mechanism in such a manner that the slider starts to move in the same direction as the substrate after the droplets have left the laser radiating position of the second laser radiating portion.

14. The apparatus according to claim 13, wherein the movement speed of the slider is set to a value smaller than the movement speed of the substrate.

15. The apparatus according to claim 1,
wherein the laser beam radiated by the first laser radiating portion has a first wavelength, and the laser beam radiated by the second laser radiating portion has a second wavelength different from the first wavelength.

16. The apparatus according to claim 15,
wherein the liquid is prepared by dispersing the functional material in a dispersion medium, the first wavelength is set in correspondence with an absorption wavelength of the dispersion medium, and the second wavelength is set in correspondence with an absorption wavelength of the functional material.

17. The apparatus according to claim 1, wherein the apparatus forms an identification code on a display module of a liquid crystal display.

18. A method for forming a predetermined pattern on a substrate by ejecting a liquid containing a functional material on the substrate through an ejection port as droplets, the method comprising:
drying the droplets that have been received by the substrate by radiating laser beams having a first wavelength; and
baking the dried droplets by radiating laser beams having a second wavelength different from the first wavelength.

19. The method according to claim 18, further comprising changing the distance between a radiating position of the laser beams having the first wavelength and a radiating position of the laser beams having the second wavelength by moving the slider in the same direction as the substrate after the droplets received by the substrate have left the radiating position of the laser beams having the second wavelength.

20. The method according to claim 19, wherein the liquid is prepared by dispersing the functional material in a dispersion medium, the first wavelength is set in correspondence with an absorption wavelength of the dispersion medium, and the second wavelength is set in correspondence with an absorption wavelength of the functional material.
